(19) United States
(12) Patent Application Publication
(10) Pub. No.: US 2012/0003404 A1
(43) Pub. Date: Jan. 5, 2012

(54) ORNAMENTAL HANGER

(76) Inventor: Lynn Hamlin, CHAPPAQUA, NY (US)

(21) Appl. No.: 13/169,396

(22) Filed: Jun. 27, 2011

Related U.S. Application Data
(60) Provisional application No. 61/360,965, filed on Jul. 2, 2010.

(51) Int. Cl. A47G 33/10; A47G 33/04; A47G 33/08; B23P 11/00

(52) U.S. Cl. 428/19; 29/525.08

(57) ABSTRACT

An ornament hanger is disclosed for hanging an ornament on a display, such as a Christmas tree. The ornament hanger includes an upper portion removably linkable to the display and a lower portion engaged with the upper portion. The lower portion includes at least two ornament retaining members, to facilitate hanging multiple ornaments from a single branch. In a preferred embodiment, the upper portion slidably engages the lower portion, thereby allowing one to adjust the position of the ornament retaining members.

### CROSS-REFERENCE TO RELATED APPLICATIONS

This application is related to patent application Ser. No. 12/122405, filed May 16, 2008 which (i) published on Jul. 2, 2009 as 20090166499; (ii) is currently abandoned and which (iii) claimed priority to provisional patent application No. 61/018,268 filed on Dec. 31, 2007. This application draws priority from U.S. Patent Application Ser. No. 61/360,965, filed Jul. 2, 2010, which is hereby incorporated by reference for all purposes as if fully set forth herein.

### BACKGROUND AND RELATED ART

Embodiments of the present invention relate to an ornament hanger of the type used at Christmas time to hang ornaments from trees, garland, wires or other supports.

The traditional metal wire hook for hanging a Christmas tree ornament on the branch of the Christmas tree has been in existence for a considerable time, but, in spite of its longevity, it possesses some disadvantages.

One problem with the traditional hook is that it carries a single ornament. Therefore, the ornaments must be hung one at a time when using the traditional hook. If one is decorating a large tree, this process can be lengthy, frustrating, and detrimental to the holiday spirit.

Another limitation of the traditional hook is that it is not possible to display multiple ornaments near each other on a single tree branch. When two traditional hooks are hung from the same branch, one hook must be positioned in front of another hook, thereby causing one ornament to block the other ornament and interfere with its display.

### SUMMARY OF EMBODIMENTS

Embodiments of the present invention relate to a method and related ornament hanger for simultaneously hanging more than one ornament onto a tree at a time. Embodiments of the present invention relate to a method and related ornament hanger for simultaneously hanging more than one ornament from a single branch.

In some embodiments, ornament hanger is disclosed for hanging an ornament on a display, such as a Christmas tree. The ornament hanger may include an upper portion removably linkable to the display and a lower portion engaged with the upper portion. The lower portion includes at least two ornament retaining members, to facilitate hanging multiple ornaments from a single branch. In a preferred embodiment, the upper portion slidably engages the lower portion, thereby allowing one to adjust the position of the ornament retaining members.

Some embodiments relate to an ornament hanger for hanging an ornament on a display, comprising: an upper portion removably linkable to the display; a lower portion engaged with the upper portion, the lower portion having at least two ornament retaining members.

In some embodiments, the upper portion is slidably engaged to the lower portion.

In some embodiments, the lower portion comprises a first ornament retaining member positioned at a first end and a second ornament retaining member positioned at a second end.

In some embodiments, the upper portion comprises a hook.

In some embodiments, the ornament retaining members comprise loops.

In some embodiments, the lower portion is bell-shaped.

In some embodiments, the lower portion comprises at least three ornament retaining members.

Some embodiments relate to an ornament hanger for hanging an ornament on a display, comprising: an upper portion having a hook; and a lower portion slidably engaged with the upper portion, the lower portion having at least two ornament retaining members.

In some embodiments, the lower portion comprises a first ornament retaining member positioned at a first end and a second ornament retaining member positioned at a second end.

In some embodiments, the ornament retaining members comprise loops.

In some embodiments, the lower portion is bell-shaped.

In some embodiments, the lower portion comprises at least three ornament retaining members.

Some embodiments relate to a hanging-ornament system comprising: a) a tree having a plurality of branches; b) a hanger suspended from one of the branches of the tree, the hanger comprising: i) an upper portion removably linkable to the branch of the tree; and ii) a lower portion slidably engaged with the upper portion, the lower portion having at least two ornament retaining members including a first ornament retaining member positioned at a first end of the lower portion and a second ornament retaining member positioned at a second end of the lower portion; and c) a plurality of ornaments suspended from the tree via the hanger, the plurality of ornaments including a first ornament suspended from the first ornament retaining member and a second ornament suspended from the second ornament retaining member such that the first and second ornaments may independently rotate while remaining respectively suspended from the first and second ornament retaining members of the lower portion.

In some embodiments, each of the first and second ornament retaining members comprise a respective loop.

In some embodiments, i) the first ornament comprises a first connector element attached to a first ball, the first ornament being suspended from the first ornament retaining member via the first connector element; and ii) the second ornament comprises a second connector element attached to a second ball, the second ornament being suspended from the second ornament retaining member via the second connector element.

In some embodiments, the first and second ornaments are substantially spherical.

In some embodiments, i) the upper portion of the hanger includes a hook including a curved section and an elongated section; and ii) the lower portion of the hanger is slidably engaged with the upper portion to allow an elongated section of the lower portion to slide in a direction substantially perpendicular to the elongated section of the hook of the upper portion.

In some embodiments, the hanger is unbalanced such that: i) the upper and lower portions of the suspended hanger are connected to each other at a connection location; and ii) the distance between the first ornament retaining member of the lower portion and the connection location is unequal to the distance between the second ornament retaining member of the lower portion and the connection location.

In some embodiments, the hanger is unbalanced such that: i) the upper and lower portions of the suspended hanger are connected to each other at a connection location; and ii) the distance between the first ornament retaining member of the lower portion and the connection location is unequal to the distance between the second ornament retaining member of the lower portion and the connection location so that the first ornament hangs lower than the second ornament from the suspended hanger.

In some embodiments, the lower portion of the hanger has only two of the ornament retaining members.

Some embodiments relate to a hanging-ornament system comprising: a) a tree having a plurality of branches; b) a hanger suspended from one of the branches of the tree, the hanger comprising: i) an upper portion removably linkable to the branch of the tree; and ii) a lower portion slidably engaged with the upper portion, the lower portion having at least two ornament retaining members including a first ornament retaining member positioned at a first end of the lower portion and a second ornament retaining member positioned at a second end of the lower portion; and c) a plurality of ornaments suspended from the tree via the hanger, the plurality of ornaments including a first ornament suspended from the first ornament retaining member and a second ornament suspended from the second ornament retaining member in a manner that allows motion of the first and second ornaments relative to each other while the first and second ornaments remaining respectively suspended from the first and second ornament retaining members of the lower portion.

In some embodiments, each of the first and second ornament retaining members comprise a respective loop.

In some embodiments, the first and second ornaments are substantially spherical.

In some embodiments, i) the upper portion of the hanger includes a hook including a curved section and an elongated section; and ii) the lower portion of the hanger is slidably engaged with the upper portion to allow an elongated section of the lower portion to slide in a direction substantially perpendicular to the elongated section of the hook of the upper portion.

In some embodiments, the hanger is unbalanced such that: i) the upper and lower portions of the suspended hanger are connected to each other at a connection location; and ii) the distance between the first ornament retaining member of the lower portion and the connection location is unequal to the distance between the second ornament retaining member of the lower portion and the connection location.

In some embodiments, the hanger is unbalanced such that: i) the upper and lower portions of the suspended hanger are connected to each other at a connection location; and ii) the distance between the first ornament retaining member of the lower portion and the connection location is unequal to the distance between the second ornament retaining member of the lower portion and the connection location so that the first ornament hangs lower than the second ornament from the suspended hanger.

In some embodiments, the lower portion of the hanger has only two of the ornament retaining members.

Some embodiments relate to a method of hanging ornaments from a tree, the method comprising: a) for each given ornament of a plurality of ornaments, engaging the given ornament to a hanger that includes: i) an upper portion; and ii) a lower portion slidably engaged with the upper portion, the lower portion having at two ornament retaining members including a first ornament retaining member positioned at a first end of the lower portion and a second ornament retaining member positioned at a second end of the lower portion, wherein the engagement is carried out so that a first ornament of the plurality is engaged to the first ornament retaining member and a second ornament of the plurality is engaged to the second ornament retaining member; and b) after the engaging of step (a), suspending the hanger from a branch of the tree via the upper portion, thereby simultaneously hanging the first and second ornaments from the tree via the first and second ornament retaining members in a manner so that after the hanging of first and second ornaments, the first and second ornaments may: i) move relative to each other while remaining simultaneously suspended from the tree respectively via the first and second ornament retaining members; and/or ii) may independently rotate while remaining simultaneously suspended from the tree respectively via the first and second ornament retaining members.

In some embodiments, the method is carried out so that after the hanging of first and second ornaments, the first and second ornaments may move relative to each other while remaining simultaneously suspended from the tree respectively via the first and second ornament retaining members

In some embodiments, the method is carried out so that after the hanging of first and second ornaments, the first and second ornaments may independently rotate while remaining simultaneously suspended from the tree respectively via the first and second ornament retaining members

In some embodiments, the lower portion of the hanger has only two of the ornament retaining members.

In some embodiments, i) the upper and lower portions of the suspended hanger are connected to each other at a connection location; and ii) the method is carried out so that after the suspending of the hanger, the distance between the first ornament retaining member of the lower portion and the connection location is unequal to the distance between the second ornament retaining member of the lower portion and the connection location so that the first ornament hangs lower than the second ornament from the suspended hanger.

Some embodiments relate to a kit comprising: a) any hanger described herein; and b) one or more of Christmas ball(s), the hanger being packaged together with the Christmas ball(s).

Some embodiments relate to a kit comprising: a) any hanger described herein; and

b) instructions instructing the user to first engage a plurality of separate decorations to the hanger, and then to hang the hanger from a tree in order to simultaneously hang the plurality of decorations from the tree via the hanger.

In some embodiments, further comprising one or more decoration items.

In some embodiments, one or more decoration items includes a closed-loop for hanging the decoration item.

In some embodiments, the closed-loop has a diameter of less than 5 cm.

In some embodiments, the diameter is less than 2.5 cm.

In some embodiments, one or more of the decoration items is a Christmas ball.

### BRIEF DESCRIPTION OF THE DRAWINGS

FIGS. 1-8 illustrate ornament hangers according various embodiments.

FIG. 9 is a flow chart of a technique for hanging ornaments from a tree.

FIG. 10 illustrate the technique of FIG. 9.

### DETAILED DESCRIPTION OF EMBODIMENTS

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. Acronyms and other descriptive terminology may be used merely for convenience and clarity and are not intended to limit the scope of the disclosure.

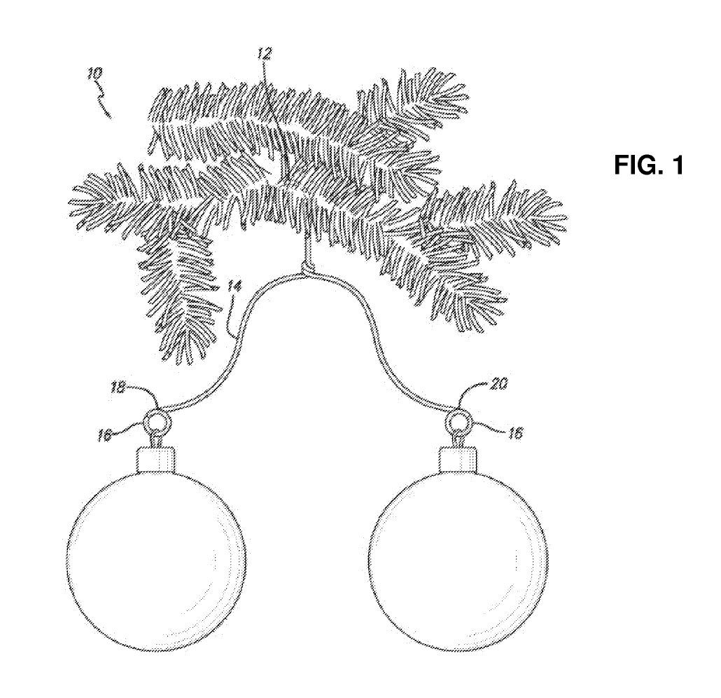

Referring now to the drawing figures, wherein like reference numerals represent like parts throughout the several views, FIG. 1 shows a preferred embodiment of an ornament hanger 10 of present invention. Ornament hanger 10 includes an upper portion 12 and a lower portion 14. The upper portion 12 is configured to hang from or fasten to a Christmas tree. A Christmas tree is used herein as an example of the type of display that can be adorned using the ornament hanger of the present invention. One skilled in the art would understand that this invention can be utilized to hang ornaments on a variety of displays, including but not limited to, garlands, plants, ornament holders, statues, structures, furniture, etc. The use of the exemplary Christmas tree is not intended to limit the scope of the invention.

In a preferred embodiment, the upper portion 12 forms a hook capable of being suspended from a Christmas tree branch. It is envisioned that the upper portion can be formed as a clamp, a loop, a fastening device for attachment to a branch or a curved shape capable of suspending the hanger from a branch.

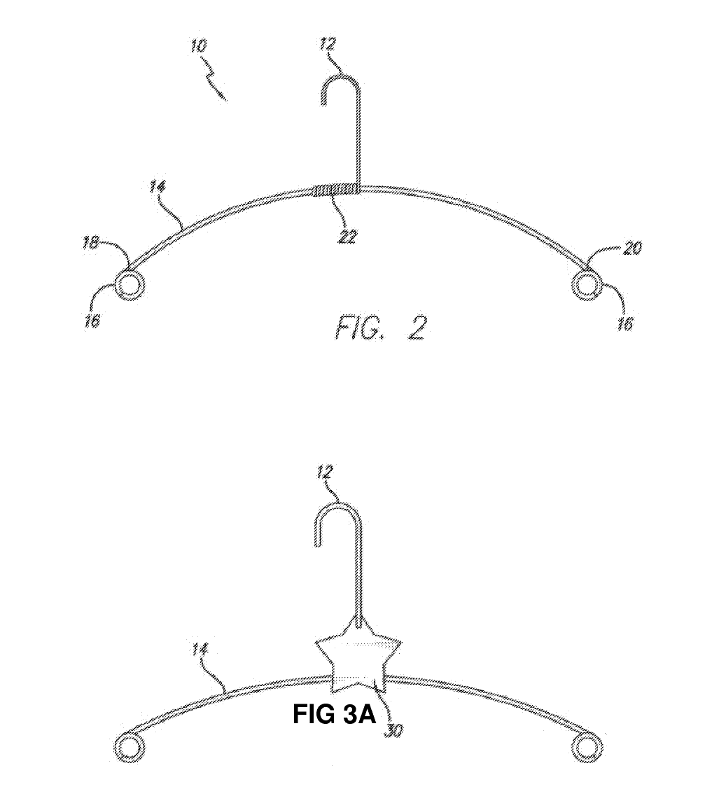

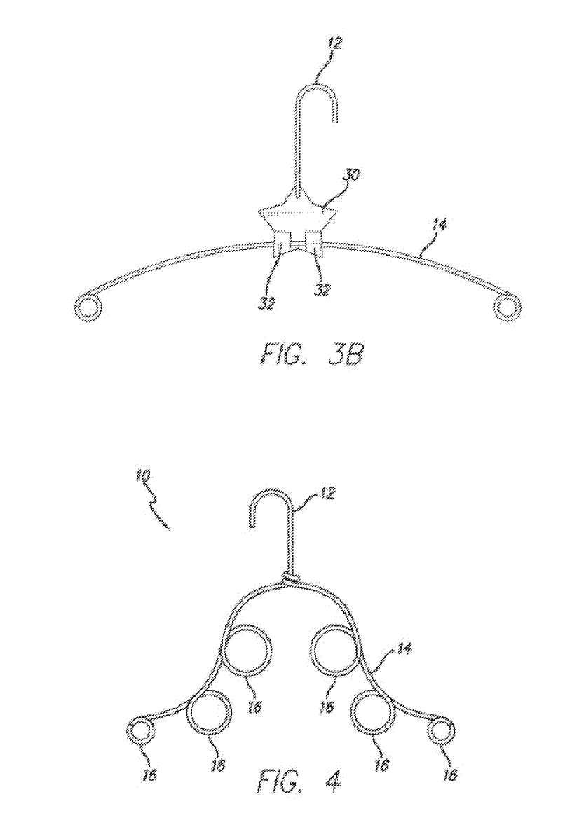

The lower portion 14 preferably forms at least two ornament retaining members 16. In one embodiment of the invention, as shown in FIG. 1, the ornament retaining members 16 are shown as loops and are positioned at a first end 18 and a second end 20 of the lower portion 14. It is envisioned that the position of the ornament retaining members 16 is not limited to an end of the lower portion 14. Rather, the ornament retaining members 16 can be positioned anywhere along the lower portion 14. The lower portion 14 can have many shapes. In FIGS. 1 and 4, the lower portion 14 is shown having a bell-shape. In FIGS. 2 and 3, the lower portion 14 has an arc-shape. It is envisioned that the lower portion 14 can have a variety of shapes and is not limited to the exemplary embodiments shown herein.

FIG. 2 shows another preferred embodiment of the invention wherein upper portion 12 is slidably engaged with lower portion 14. In one embodiment, upper portion 12 has a coil end 22 configured to entwine lower portion 14 in a manner that frictionally holds the lower portion 14. Coil end 22 slidably engages the lower portion 14 and its position can be selectively adjusted on the lower portion 14. By adjusting the position of the coil end 22 on the lower portion 14, one can control the position of an ornament retaining portion 16 at a first end 18 relative to the other ornament retaining portion 16 at the second end 20. In the embodiment shown in FIG. 2, if the coil end 22 is equidistant from the first end 18 and second end 20, the ornament retaining portions 16 will be positioned on the same plane. If the coil end 22 is slidably adjusted to be closer to one end than the other, the ornament retaining portions will no longer be positioned on the same plane.

FIGS. 3A and 3B depict another exemplary embodiment of the invention wherein the position of the upper portion 12 of the ornament hanger 10 can be selectively adjusted with respect to the lower portion 14. As shown in FIGS. 3A and 38, the upper portion 12 is attached to a slider 30 and slider 30 is slidably engaged with lower portion 14. In one embodiment Of the invention, slider 30 has engaging members 32 that grip the lower portion 14, while allowing the slider 30 to slide along the lower portion 14 when force is applied thereto.

The interengagement of the slider 30 and the lower portion 14 can be accomplished using many known devices. For example, engaging members 32 can be springs that are biased in a manner that grips the lower portion 14. In another example, engaging members 32 can include two holes through which lower portion 14 may pass. The holes would be sized to grip the lower portion 14 while allowing lower portion 14 to slide through when force is applied thereto. The present invention is not intended to be limited to the examples provided herein. Those skilled in the art will understand that there are numerous ways to slidingly engage the upper and lower portions without diverting from the scope of the invention.

FIG. 4 depicts yet another embodiment of the invention wherein the lower portion 14 of the ornament hanger 10 includes more than two ornament retaining members 16. In the embodiment shown in FIG. 4, lower portion 14 includes six ornament retaining members 16. The ornament retaining members 16 can be of various sized to accommodate different sized ornament. The ornament hanger 10 shown in FIG. 4 can be utilized to hang several smaller ornaments or a collection of related ornaments.

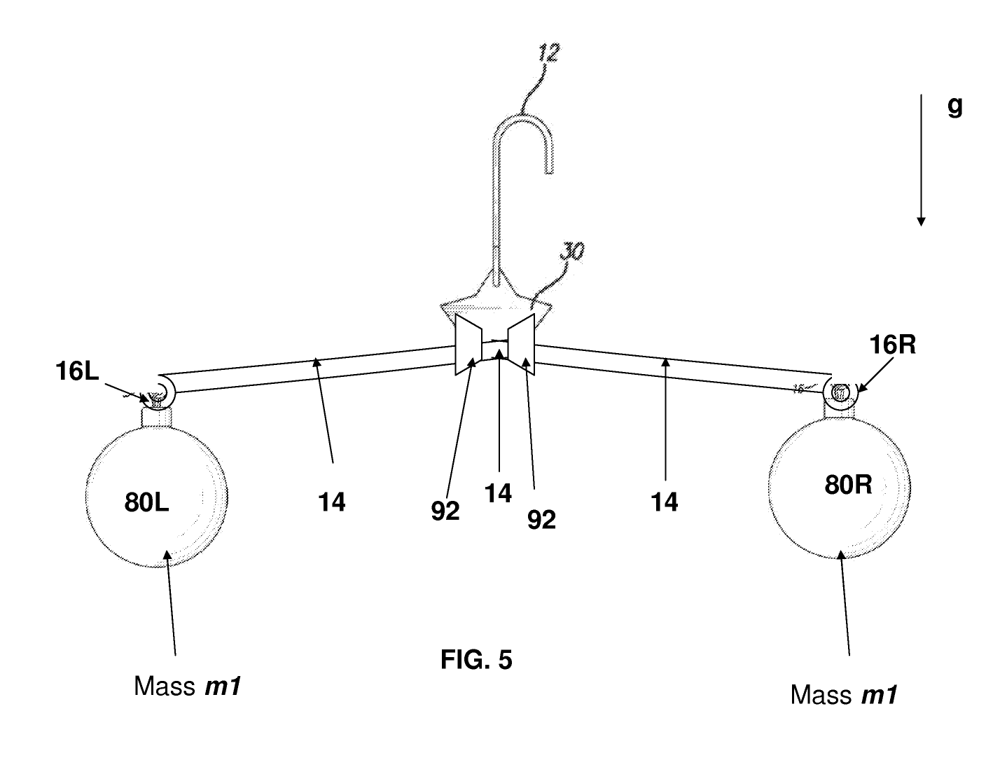

FIGS. 5-8 illustrate several use cases related to the embodiments of FIG. 3. In the examples of FIGS. 3, 5-8 the hanging device includes slider 30. Slider 30 may include two ‘mode’ or ‘configurations’—in the ‘first mode,’ movement of the elongated element 14 through one or more regions of slider 30 may be permitted—this may be used to adjust the relative distances of ornament-retaining members 16 from the slider 30 (or a portion thereof).

In the ‘second mode,’ movement of the elongated element 14 through one or more regions of sliders 30 may be hindered or forbidden, in order to fix the relative distance of each ornament-retaining member 16 from slider 30.

In the non-limiting example of FIG. 5, the weight of each ornamental item is equal, the distance of each ornament-retaining member 16L and 16R from slider 30 is equal.

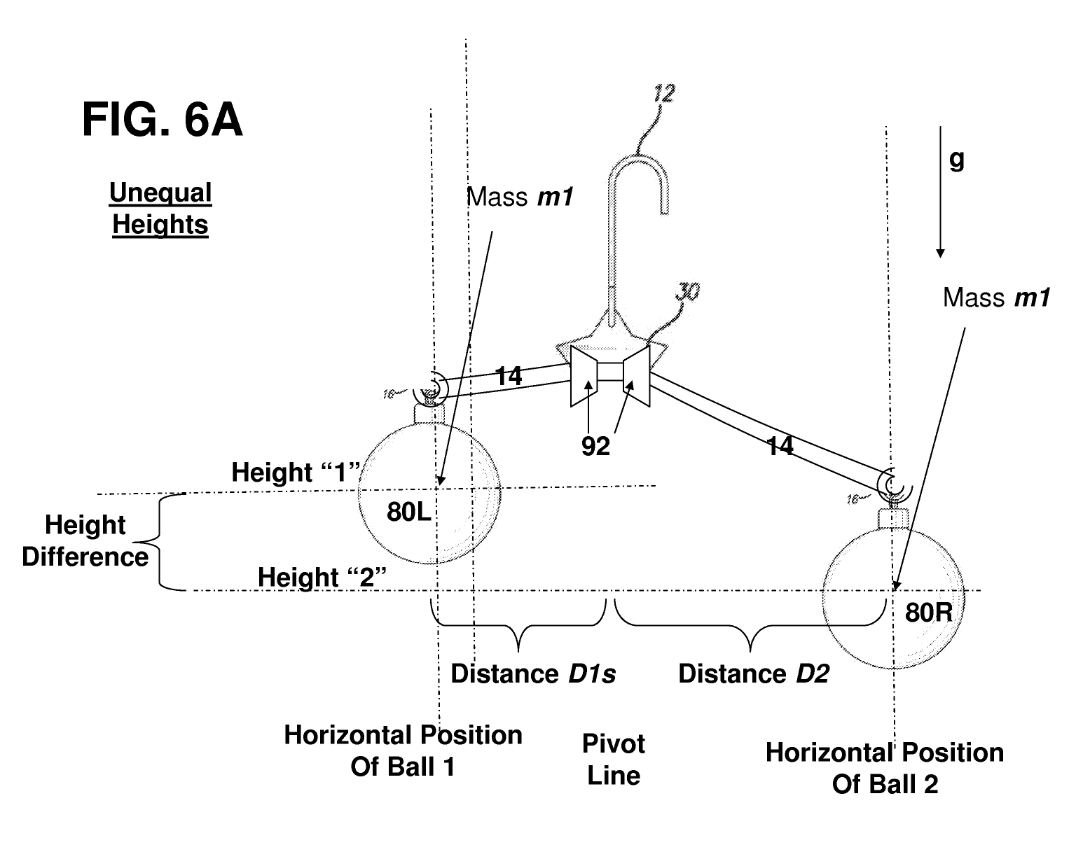

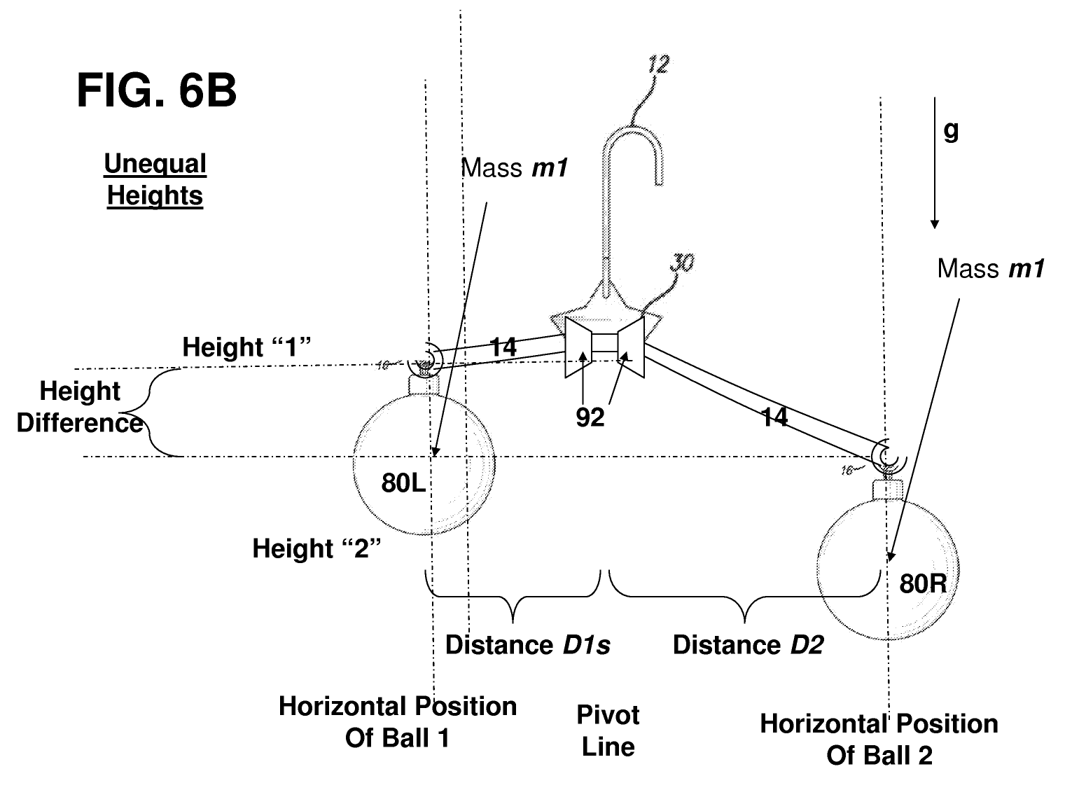

In one non-limiting use case, the user may modify the hanger configuration of FIG. 5 to obtain the hanger configuration of FIG. 6. For example, the user may hold or receive or possess a hanger having hanger configuration of FIG. 5. In this case, the slider will be in the ‘second mode’ where the respective distances of between each ornament-retaining member and the slider is fixed (for example, by a clamping and/or gripping and/or locking mechanism of slider 30, or any other mechanism for hindering preventing motion of elongated element 14 through slider 30).

In this use case, after the user ‘frees up’ elongated element 14 to permit motion through slider 30, it is possible to create an ‘unbalanced configuration’ where one ornament-retaining member 16 (in FIG. 6, ornament-retaining member 16L) is ‘closer to the center of the hanger’ and/or ‘closer to slider 30’ than the other ornament-retaining member 16 (in FIG. 6, ornament-retaining member 16R). It is then possible to maintain this ‘unbalanced configuration’ by bringing slider 30 back to the ‘first mode’ so that the slider clamps and/or grips and/or locks and/or otherwise hinders or prevents sliding motion of elongated element 14 through slider 30.

FIGS. 13A-13B illustrate on non-limiting example of a slider 30.

In FIG. 6, it is possible to maintain an ‘unbalanced configuration.’ The ornaments have the same mass but one of the ornament-retaining members is higher than the other ornament retaining member. The ‘horizontal distance D2’ between one of the ornament members 16R and slider and/or the ‘hanging location’ by which the hanger is hung exceeds ‘horizontal distance D1’ between the other ornament members 16L and slider and/or the ‘hanging location’ by which the hanger is hung. In some embodiments, one of the horizontal distances may exceed the other horizontal distance by at least 20% or at least 30% or at least 50% or at least 80% or at least 100%.

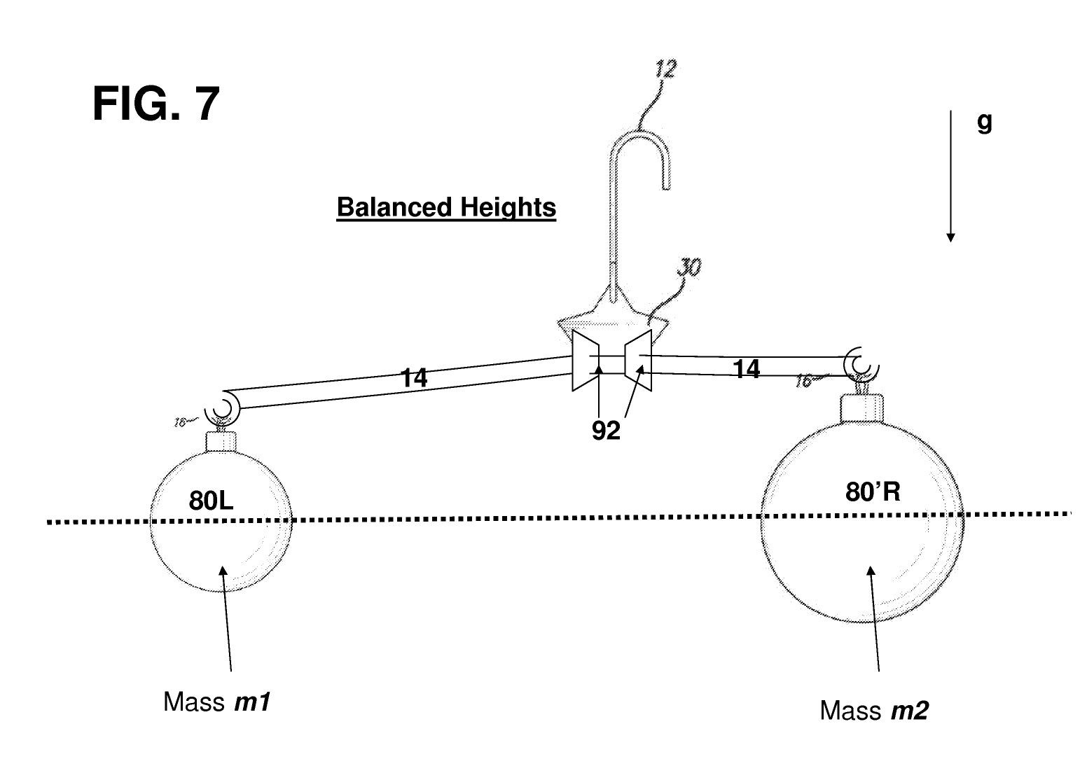

In FIG. 7, the ornaments may have unequal masses. In different examples, one mass m2 may exceed the other mass m1 by at least 20% or at least 30% or at least 50% or at least 80% or at least 100%. Nevertheless, it is possible to use slider to maintain a balance by moving horizontal member 14 so that the ornament-retaining member 16R holding the heavier ornament is closer to the ‘center’ and/or to slider 30. It is appreciated that embodiments of FIGS. 6 and 7 may be combined—‘unbalanced’ and/or ‘unequal height’ ornament-retaining members holding decorations of unequal mass.

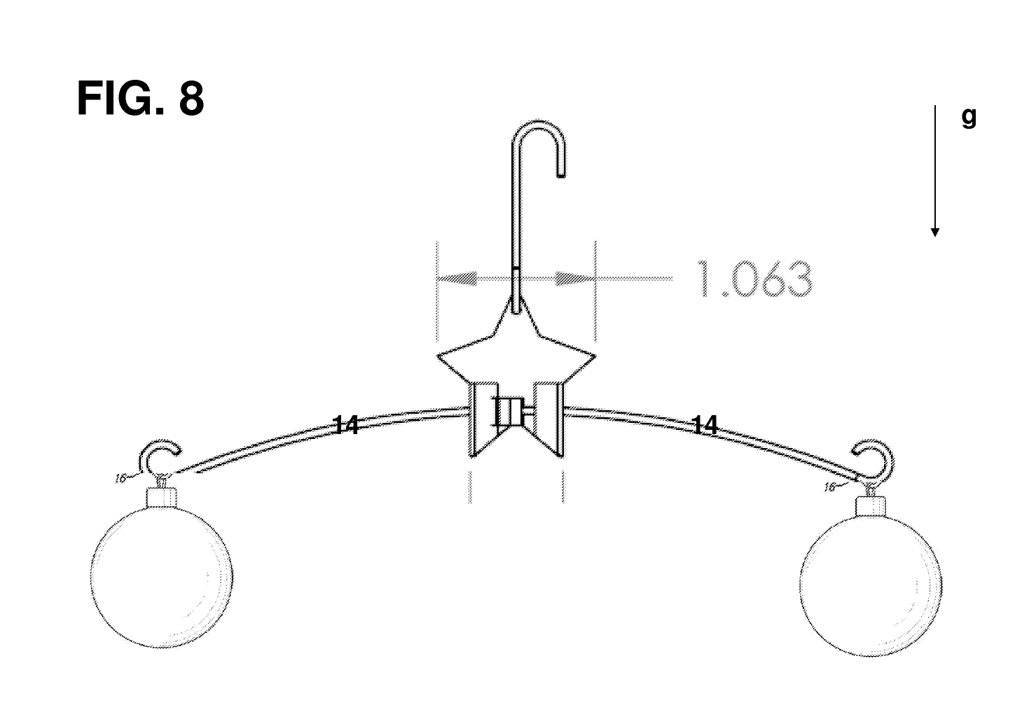

In FIG. 8, the ornament retaining members are open hooks rather than closed loops—this may be useful for hanging Christmas balls (or any other ornament) having an upper closed loop.

One observation about FIGS. 1-8: in some embodiments, the ornaments may rotate or translate relative to each other—for example, each Christmas ball may rotate independently of each other (e.g. a ‘swinging motion not unlike a child on a swing’) around a substantially horizontal axis—i.e. each ornament (e.g. Christmas ball) 30 may move independently of the other. They are not required to be rigidly attached to each other while remaining suspended from a respective retaining member 16.

FIGS. 8-10 illustrate a technique for hanging decorations (e.g. Christmas decorations) from a tree (e.g. a Christmas tree). In step S101, multiple ornaments (e.g. each hanger receives two or more ornaments) are hung from a hanger while the hanger is ‘off the tree’ and not suspended from the tree. In step S105, at a later time, one or more ‘multiple-ornament-laden hangers’ are then hung from the tree (e.g. branches of the tree). Each ‘hanging act’ of hanging a ‘multiple-ornament-laden hanger’ may be useful for simultaneously hanging multiple ornaments from the tree—for example, these multiple ornaments may be configured to allow independent rotation or any other independent motion relative to each other.

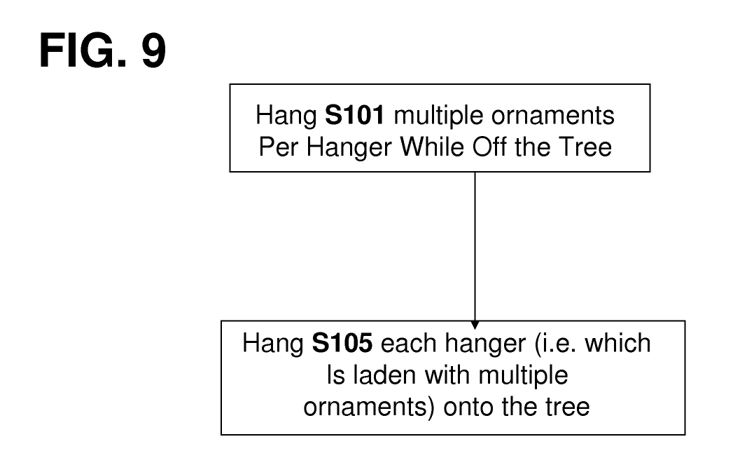

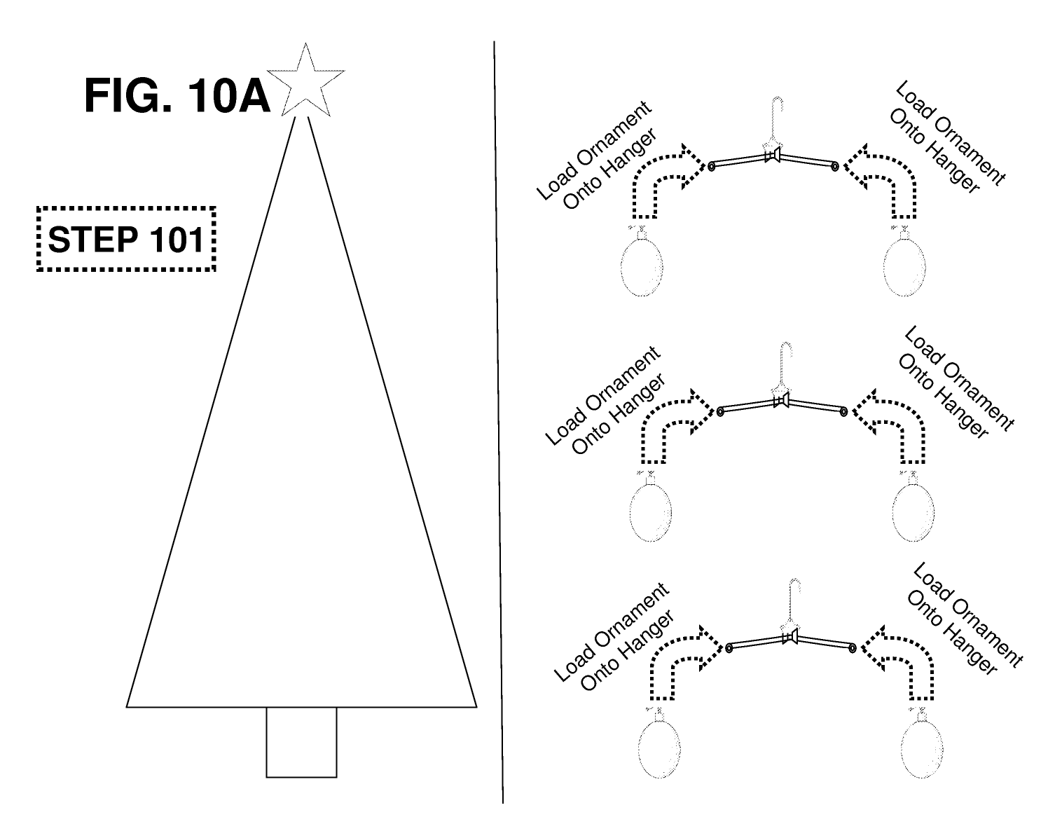

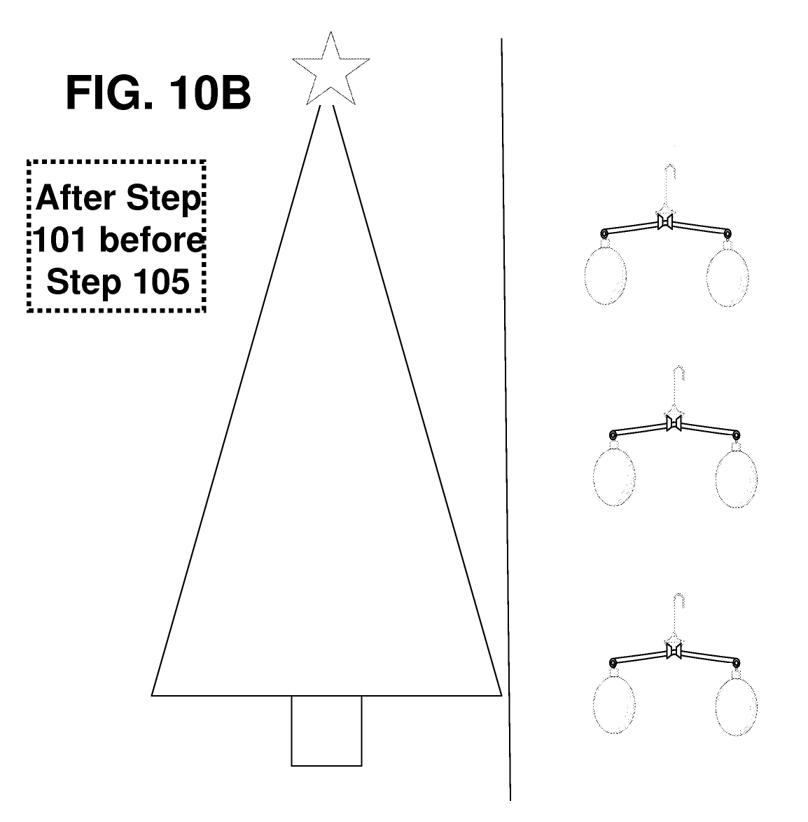

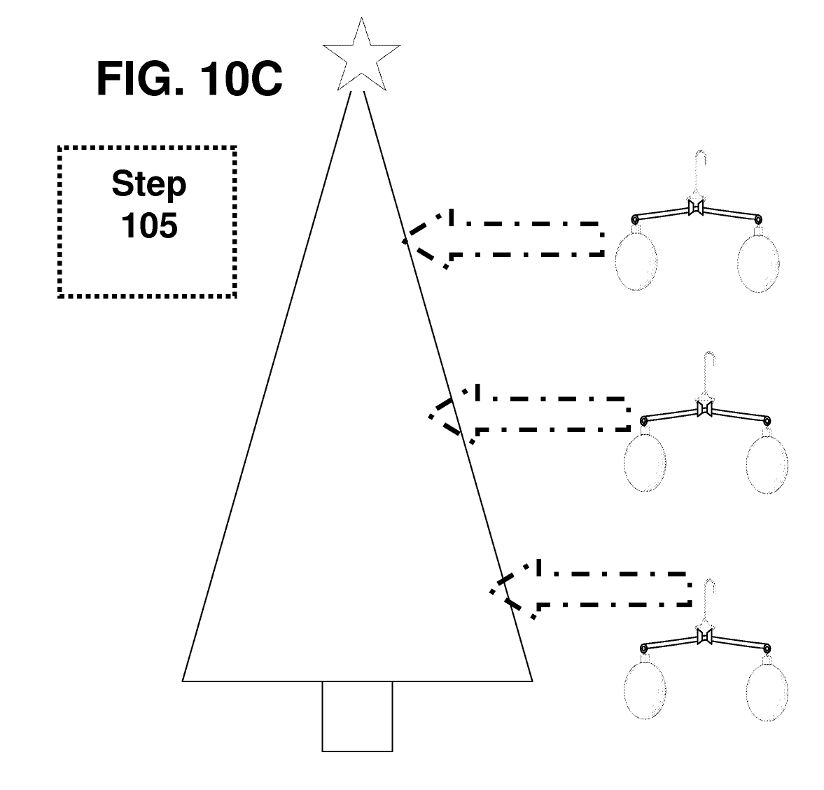

FIGS. 10A-10D illustrate one example related to the method of FIG. 9. In FIG. 10A, multiple ornaments 30 are each hung from respective hangers—for each hanger, each ornament (i.e. of an ‘ornament array’ of 2 or more ornaments) are each hung from a respective retaining element 16. In FIG. 10B, it is possible to view each ‘multiple-ornament-laden hanger.’

In FIG. 10C, one or more of these ‘multiple-ornament-laden hangers’ are then hunger from the tree, in step S105, to produce the result visible in FIG. 10D.

Some embodiments of the present invention relate to a kit including one or more hangers disclosed herein, and one or more decoration items. In one example, the kit may include one or more Christmas balls—e.g. a shiny ball connected to a relatively small hook for hanging the ball.

In some embodiments, the kit may include instructions for hanging decorations on a tree (for example, see FIGS. 9-10). The instructions may instruct the user to first hang (or otherwise engage) a plurality of decorations from the hanger, and then to subsequently hang the decoration-laden hanger (i.e. to which multiple decorations are separately hung or attach) from a display or tree—for example, a Christmas tree. The instructions may be packaged together with the pre-assembled hanger or with the hanger provided as a plurality of parts.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of hanging ornaments from a tree, the method comprising:
a) for each given ornament of a plurality of ornaments, engaging the given ornament to a hanger that includes:
i) an upper portion; and
ii) a lower portion slidably engaged with the upper portion, the lower portion having at two ornament retaining members including a first ornament retaining member positioned at a first end of the lower portion and a second ornament retaining member positioned at a second end of the lower portion,
wherein the engagement is carried out so that a first ornament of the plurality is engaged to the first ornament retaining member and a second ornament of the plurality is engaged to the second ornament retaining member; and
b) after the engaging of step (a), suspending the hanger from a branch of the tree via the upper portion, thereby simultaneously hanging the first and second ornaments from the tree via the first and second ornament retaining members in a manner so that after the hanging of first and second ornaments, the first and second ornaments:
i) are free to move relative to each other while remaining simultaneously suspended from the tree respectively via the first and second ornament retaining members; and/or
ii) are free to independently rotate while remaining simultaneously suspended from the tree respectively via the first and second ornament retaining members.

2. The method of claim 1 wherein the method is carried out in a manner so that after the hanging of first and second ornaments, the first and second are free to move relative to each other while remaining simultaneously suspended from the tree respectively via the first and second ornament retaining members

3. The method of claim 1 wherein the method is carried out in a manner so that after the hanging of first and second ornaments, the first and second are free to independently rotate while remaining simultaneously suspended from the tree respectively via the first and second ornament retaining members.

4. The method of claim 1 wherein the lower portion of the hanger has only two of the ornament retaining members.

5. The method of claim 1 wherein:
i) the upper and lower portions of the suspended hanger are connected to each other at a connection location; and
ii) the method is carried out so that after the suspending of the hanger, the distance between the first ornament retaining member of the lower portion and the connection location is unequal to the distance between the second ornament retaining member of the lower portion and the connection location so that the first ornament hangs lower than the second ornament from the suspended hanger.

6. An ornament system comprising:
a) a tree having a plurality of branches;
b) a hanger suspended from one of the branches of the tree, the hanger comprising:
i) an upper portion removably linkable to the branch of the tree; and
ii) a lower portion slidably engaged with the upper portion, the lower portion having at least two ornament retaining members including a first ornament retaining member positioned at a first end of the lower portion and a second ornament retaining member positioned at a second end of the lower portion; and
c) a plurality of ornaments suspended from the tree via the hanger, the plurality of ornaments including a first ornament suspended from the first ornament retaining member and a second ornament suspended from the second ornament retaining member such that the first and second ornaments may independently rotate while remaining respectively suspended from the first and second ornament retaining members of the lower portion.

7. The system of claim 6 wherein each of the first and second ornament retaining members comprise a respective loop.

8. The system of claim 6 wherein:
i) the first ornament comprises a first connector element attached to a first ball, the first ornament being suspended from the first ornament retaining member via the first connector element; and
ii) the second ornament comprises a second connector element attached to a second ball, the second ornament being suspended from the second ornament retaining member via the second connector element.

9. The system of claim 6 wherein the first and second ornaments are substantially spherical.

10. The system of claim 6 wherein:
i) the upper portion of the hanger includes a hook including a curved section and an elongated section; and
ii) the lower portion of the hanger is slidably engaged with the upper portion to allow an elongated section of the lower portion to slide in a direction substantially perpendicular to the elongated section of the hook of the upper portion.

11. The system of claim 6 wherein hanger is unbalanced such that:
i) the upper and lower portions of the suspended hanger are connected to each other at a connection location; and
ii) the distance between the first ornament retaining member of the lower portion and the connection location is unequal to the distance between the second ornament retaining member of the lower portion and the connection location.

12. The system of claim 16 wherein hanger is unbalanced such that:
i) the upper and lower portions of the suspended hanger are connected to each other at a connection location; and
ii) the distance between the first ornament retaining member of the lower portion and the connection location is unequal to the distance between the second ornament retaining member of the lower portion and the connection location so that the first ornament hangs lower than the second ornament from the suspended hanger.

13. The system of claim 6 wherein the lower portion of the hanger has only two of the ornament retaining members.

14. An ornament system comprising:
a) a tree having a plurality of branches;
b) a hanger suspended from one of the branches of the tree, the hanger comprising:
i) an upper portion removably linkable to the branch of the tree; and
ii) a lower portion slidably engaged with the upper portion, the lower portion having at least two ornament retaining members including a first ornament retaining member positioned at a first end of the lower portion and a second ornament retaining member positioned at a second end of the lower portion; and
c) a plurality of ornaments suspended from the tree via the hanger, the plurality of ornaments including a first ornament suspended from the first ornament retaining member and a second ornament suspended from the second ornament retaining member in a manner that allows motion of the first and second ornaments relative to each other while the first and second ornaments remaining respectively suspended from the first and second ornament retaining members of the lower portion.

15. The system of claim 14 wherein each of the first and second ornament retaining members comprise a respective loop.

16. The system of claim 14 wherein the first and second ornaments are substantially spherical.

17. The system of claim 14 wherein:
i) the upper portion of the hanger includes a hook including a curved section and an elongated section; and
ii) the lower portion of the hanger is slidably engaged with the upper portion to allow an elongated section of the lower portion to slide in a direction substantially perpendicular to the elongated section of the hook of the upper portion.

18. The system of claim 14 wherein hanger is unbalanced such that:
i) the upper and lower portions of the suspended hanger are connected to each other at a connection location; and
ii) the distance between the first ornament retaining member of the lower portion and the connection location is unequal to the distance between the second ornament retaining member of the lower portion and the connection location.

19. The system of claim 14 wherein hanger is unbalanced such that:
i) the upper and lower portions of the suspended hanger are connected to each other at a connection location; and
ii) the distance between the first ornament retaining member of the lower portion and the connection location is unequal to the distance between the second ornament retaining member of the lower portion and the connection location so that the first ornament hangs lower than the second ornament from the suspended hanger.

20. The system of claim 14 wherein the lower portion of the hanger has only two of the ornament retaining members.
